(19) United States
(12) Patent Application Publication
(10) Pub. No.: US 2004/0004037 A1
(43) Pub. Date: Jan. 8, 2004

(54) Direct osmotic hydration devices

(76) Inventor: Jack Herron, Corvallis, OR (US)

Correspondence Address: JEFFREY B. OSTER, 8339 SE 57TH ST, MERCER ISLAND, WA, 98040, US

(21) Appl. No.: 10/317,540

(22) Filed: Dec. 11, 2002

Related U.S. Application Data
(60) Provisional application No. 60/340,391, filed on Dec. 12, 2001.

(51) Int. Cl. B01D 63/10; B01D 63/00

(52) U.S. Cl. 210/321.83; 210/321.72; 210/321.88; 210/321.89; 210/257.2

(57) ABSTRACT

There is disclosed a hydration bag for providing potable or even sterile water from contaminated water sources. Specifically, there is disclosed two embodiments of a passive membrane osmotic device. The first embodiment has an interior space sealed with one or two membrane walls, having an osmotic agent formulation within the interior space, and having direct osmotic concentration properties. The second embodiment has a sealable nutrient/osmotic agent chamber with a spiral wound membrane wrapped around the nutrient/osmotic agent chamber to form the membrane element, wherein the membrane element is located within a sealable dirty water compartment or within a dirty water source and wherein the membrane element communicates with a clean water compartment. More specifically, the osmotic agent or nutrient can be a partially dehydrated food source, a sugar, a medicine, or combinations thereof.

### CROSS REFERENCE TO RELATED APPLICATION

This patent application claims priority from U.S. Provisional Patent Application No. 60/340,391 filed Dec. 12, 2001.

### TECHNICAL FIELD OF THE INVENTION

The present invention provides a hydration bag for providing potable or even sterile water from contaminated water sources. Specifically, the present invention provides two embodiments of a passive membrane osmotic device. The first embodiment has an interior space sealed with one or two membrane walls, having an osmotic agent formulation within the interior space, and having direct osmotic concentration properties. The second embodiment has a sealable nutrient/osmotic agent chamber with a spiral wound membrane wrapped around the nutrient/osmotic agent chamber to form the membrane element, wherein the membrane element is located within a sealable dirty water compartment or within a dirty water source and wherein the membrane element communicates with a clean water compartment. More specifically, the osmotic agent or nutrient can be a partially dehydrated food source, a sugar, a non-nutritive osmotic agent, a medicine, or combinations thereof.

### BACKGROUND OF THE INVENTION

During disasters, such as earthquakes and floods, often the greatest loss of life from the event and the aftermath occurs due to a lack of clean and potable drinking water and a lack of relief supplies. During floods and earthquakes the municipal drinking water is often destroyed and disaster relief agencies generally try to first provide drinking water to avoid having people drink from contaminated supplies. In more remote areas, due to a lack of rapid road access, relief supplies are often air-dropped. Therefore, air-dropping drinking water is a difficult and challenging task. Therefore, there is a need to be able to create potable and nourishing drinking water at a disaster site without dropping off large quantities of water.

At remote locations, clean water and sterilization facilities do not often exist. Therefore, there is a need to be able to simply create uncontaminated solutions suitable to injection or ingestion. Generally, such sites are served by transporting sterile solutions or both a sterile solute (i.e., drug) and sterile water in bottles and other containers to remote locations. Alternatively, contaminated water sources are cleaned up on site, generally through reverse osmosis filtration or some evaporation and condensation technique. However, in situ preparation of clean water from a contaminated source generally requires large amounts of energy to drive the process.

Similar problems can be encountered in camping or conducting operations in remote locations. In such situations, particularly when the operations last for many days, it is impractical to carry large amounts of clean water for drinking and cooking and even the food carried should be in a dehydrated or partially dehydrated form for purposes of limiting the amount of weight being transported. The ability to create potable water from contaminated or even questionable sources is important for backpackers or certain military operations. Currently, water can be made safer from contamination through boiling. However this is time-consuming, requires fuel or an energy source and also requires that the user stay put for a period of time. Moreover, clean water is needed to prepare a meal from a dehydrated or partially dehydrated source. Therefore, there is a need in the art to be able to create clean, drinkable water quickly and without using fuel supplies. The present invention addresses the foregoing needs.

Other attempts at creating sterile solutions or drinkable water through an osmotic process have been tried. However, none of the previous approaches have produced a commercially viable product having flux rates needed to obtain reasonable use of such a product. Specifically, U.S. Pat. No. 4,920,105 describes a fully membrane pouch or bag composed of membrane materials. In order to achieve the structure of a pouch or bag, a nanofiltration membrane is used with about a 20,000 daltons cutoff. While preventing passage of microorganisms, the nanofiltration pouch or bag does allow passage of organic molecules, heavy metal ions, pesticides, chlorinated solvents and the like. Therefore, this pouch can create “sterile” solutions (once the pouch is pre-sterilized), it cannot prevent contamination from non-microbial sources that are often found in contaminated water supplies in disaster areas or during military operations.

For the purposes of this patent application, nanofiltration refers to membranes whose cutoff is 1000 Daltons or less, but generally above 100-200 Daltons. Ultrafiltration refers to membranes whose cutoff is from about 1000 Daltons to about 1.0 microns (size).

In addition, WO98/41314 describes a pouch or bag for rehydrated solute solutions that is composed solely of a composite membrane. The composite membrane has a support layer with a molecular weight cutoff from 1000 to 50,000 daltons and an exclusion layer with a cutoff of from 300 to 2000 daltons. This pouch or bag has extremely slow flux rates and its membrane construction will make it most fragile and not robust enough for the rigors of field use.

### SUMMARY OF THE INVENTION

The present invention provides a passive membrane device to provide potable water, medicine, sterile solutions (such as for intravenous use or for diarrhea treatment and rehydration), and food for use in disaster relief, or hiking when weight considerations are important. Specifically, the present invention provides a passive membrane device comprising:

(a) a sealed bag made from two flexible polymeric sheets circumferentially sealed to each other and describing an expandable interior space, wherein at least one of the sheets comprises a window cut out;

(b) an asymmetric membrane mounted within the window cut out of the polymeric sheet, wherein the asymmetric membrane comprises a polymeric material caste upon a porous woven or non-woven sheet or screen having at least 30% open area; and

(c) an osmotic agent contained within the expandable interior space;

whereby the osmotic agent within the expandable interior space is able to osmotically drive water across the asymmetric membrane into the interior space.

Preferably, the polymeric sheets are made from a non-porous and flexible plastic in a sheet form. Most preferably, the polymeric sheets are made from a polymeric material selected from the group consisting of PVC (polyvinyl chloride), polyethylene, polycarbonate, vinyl chloride, polyurethane, and combinations thereof. Most preferably, the polymeric sheet is made from PVC. Preferably, the window cut out is in the shape of a rectangle. Preferably, the asymmetric membranes are backed with a woven sheet. Most preferably, the woven sheet is a polyester screen. Most preferably, the woven sheet comprises a dense polypropylene nonwoven fabric that has been surface modified with acrylic acid to make it hydrophilic. Preferably, the porous sheet contains from about 30% to about 80% open area. Most preferably the porous sheet comprises approximately 55% open area. Preferably, the asymmetric membrane is from about 100 to about 300 microns thick (including the woven sheet). Preferably, the asymmetric membrane is made from a hydrophilic membrane forming material, such as a cellulose material. Most preferably, the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof. Most preferably, the membrane material is cellulose triacetate. Preferably, for storage after casting, the asymmetric membrane has its water replaced by a polyhydroxy compound. Most preferably, the polyhydroxy compound is selected from the group consisting of glycerin, ethyldialcohol, ethylene glycol, a C₂₋₁₀ saturated or unsaturated fatty acid, and combinations thereof. Most preferably, the polyhydroxy compound is glycerin.

Preferably, the osmotic agent has an osmotic concentration of from about 2 bar to about 200 bar (i.e., saturated salt brine). Preferably, the osmotic agent is a carbohydrate. Most preferably, the osmotic agent is a monosaccharide or a disaccharide or a combination of both. Preferably, the osmotic agent is a dehydrated food.

The present invention further provides a process for manufacturing a hydration bag having two sided walls, wherein the hydration bag comprises a sealed bag having a membrane wall and an osmotic agent contained within, comprising:

(a) providing two flexible polymeric sheets, each shaped for a side wall of the hydration bag, and wherein at least one of the flexible polymeric sheets comprises a window cut out;

(b) providing an asymmetric membrane comprising a polymeric material cast upon a porous woven or non-woven sheet or screen having at least 30% open area;

(c) adhering the asymmetric membrane to cover the window on one or two flexible polymeric sheets;

(d) placing a dried osmotic agent on the membrane adhered within the window of a flexible polymeric sheet; and

(e) adhering two flexible polymeric sheets to each other by forming a weld circumferentially around the asymmetric membrane, whereby such that a bag is formed having the osmotic agent contained within an interior space.

Preferably, the process further comprises (a′) replacing water within the asymmetric membrane with a polyhydroxy compound. Most preferably, the polyhydroxy compound is selected from the group consisting of glycerin, ethyldialcohol, ethylene glycol, a C₂₋₁₀ saturated or unsaturated fatty acid, and combinations thereof. Most preferably, the polyhydroxy compound is glycerin. Preferably, the process for (c) adhering the asymmetric membrane to cover the window on one or two flexible polymeric sheets, comprises a process selected from the group consisting of solvent welding, gluing, epoxy-bonding, heat-bonding, radio frequency welding, and combinations thereof. Most preferably, the process for adhering the asymmetric membrane is radio frequency welding the backing side of the asymmetric membrane or side having the porous sheet or screen to the flexible polymeric sheet.

Preferably, the polymeric sheets are made from a non-porous and flexible plastic in a sheet form. Most preferably, the polymeric sheets are made from a polymeric material selected from the group consisting of PVC (polyvinyl chloride), polyethylene, polycarbonate, vinyl chloride, ethylene vinyl acetate, polyurethane, and combinations thereof. Most preferably, the polymeric sheet is made from PVC. Preferably, the window cut out is in the shape of a rectangle. Preferably, the asymmetric membranes are backed with a woven sheet. Most preferably, the woven sheet is a polyester screen. Preferably, the porous sheet contains from about 30% to about 80% open area. Most preferably the porous sheet comprises approximately 55% open area. Preferably, the asymmetric membrane is from about 100 to about 300 microns thick (including the woven sheet). Preferably, the asymmetric membrane is made from a hydrophilic membrane forming material, such as a cellulose material. Most preferably, the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof. Most preferably, the membrane material is cellulose triacetate.

Preferably, the osmotic agent has an osmotic concentration (pressure) of from about 2 bar to about 200 bar. Preferably, the osmotic agent is a carbohydrate. Most preferably, the osmotic agent is a monosaccharide or a disaccharide or a combination of both. Preferably, the osmotic agent is a dehydrated food.

Preferably, the process (e) adhering two flexible polymeric sheets to each other by forming a weld circumferentially around the asymmetric membrane, comprises an adhering process selected from the group consisting of radio frequency welding, gluing, epoxy welding, heat fusing, solvent welding, clamping, sonic bonding, and combinations thereof. Most preferably, the adhering process is radio frequency welding.

Further still, the present invention provides a reusable, spiral wound passive membrane device comprising:

(a) a spiral wound membrane element comprising a membrane sandwich wound around a perforated osmotic agent tube, wherein the osmotic agent perforated tube having two sealable ends and lateral walls, wherein the osmotic agent perforated tube comprises a plurality of openings on the lateral walls communicating with a membrane sandwich, wherein the membrane sandwich comprises a membrane, a permeate spacer, and partial length glue to form a barrier;

(b) a dirty water chamber comprising a fixed or portable container of dirty water communicating with outer portion of the spiral wound membrane envelope of the membrane element; and

(c) a potable water compartment communicating with interior of the membrane envelope of the membrane element.

Preferably, the membrane in the membrane element is an asymmetric membrane. Preferably, the asymmetric membrane is backed with a woven sheet. Most preferably, the woven sheet is a polyester screen. Preferably, the porous sheet contains from about 30% to about 80% open area. Most preferably the porous sheet comprises approximately 55% open area. Preferably, the asymmetric membrane is from about 100 to about 300 microns thick (including the woven sheet). Preferably, the membrane is made from a hydrophilic membrane forming material, such as a cellulose material. Most preferably, the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof. Most preferably, the membrane material is cellulose triacetate. Preferably, the asymmetric membrane has its water replaced by a polyhydroxy compound. Most preferably, the polyhydroxy compound is selected from the group consisting of glycerin, ethyldialcohol, ethylene glycol, a C₂₋₁₀ saturated or unsaturated fatty acid, and combinations thereof. Most preferably, the polyhydroxy compound is glycerin.

Preferably, the osmotic agent has an osmotic concentration of from about 1 bar to about 200 bar. Preferably, the osmotic agent is a carbohydrate. Most preferably, the osmotic agent is a monosaccharide or a disaccharide or a combination of both. Preferably, the osmotic agent is a dehydrated food.

The present invention further provides reusable, spiral wound passive membrane device comprising:

(a) a spiral wound element having an inner portion and an outer portion, comprising a membrane sandwich that winds around a perforated feed tube to form the inner portion, wherein the perforated feed tube comprises two sealable ends and lateral walls, wherein the perforated feed tube further comprises a plurality of openings on the lateral walls communicating with a membrane sandwich, wherein the membrane sandwich comprises a sandwich having a membrane element, a permeate spacer element, and a partial length barrier forming an elongated chamber within the membrane sandwich, wherein the outer portion of the spiral wound element comprises openings communicating with the permeate spacer element;

(b) an osmotic agent chamber comprising a fixed or portable container having an inlet port communicating with a first sealable end of the perforated feed tube;

(c) a potable water collection chamber communicating with a second sealable end of the perforated feed tube and

(d) a water feed supply so that water is continuously fed to the elongated chamber within the membrane sandwich.

Preferably, the partial length barrier element is selected from the group consisting of glue, tape, a moldable polymeric material, and combinations thereof. Preferably, the osmotic agent chamber further comprises an osmotic agent feed chamber communicating with the inlet port of the osmotic agent chamber. Preferably, the spiral wound membrane element is oriented such that its axis is oriented in a vertical direction.

Preferably, the membrane in the membrane element is an asymmetric membrane. Preferably, the asymmetric membrane is backed with a woven sheet. Most preferably, the woven sheet is a polyester screen. Preferably, the porous sheet contains from about 30% to about 80% open area. Most preferably the porous sheet comprises approximately 55% open area. Preferably, the asymmetric membrane is from about 100 to about 300 microns thick (including the woven sheet). Preferably, the membrane is made from a hydrophilic membrane forming material, such as a cellulose material. Most preferably, the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof. Most preferably, the membrane material is cellulose triacetate. Preferably, the asymmetric membrane has its water replaced by a polyhydroxy compound. Most preferably, the polyhydroxy compound is selected from the group consisting of glycerin, ethyldialcohol, ethylene glycol, a C₂₋₁₀ saturated or unsaturated fatty acid, and combinations thereof. Most preferably, the polyhydroxy compound is glycerin.

Preferably, the osmotic agent has an osmotic concentration of from about 1 bar to about 200 bar. Preferably, the osmotic agent is a carbohydrate. Most preferably, the osmotic agent is a monosaccharide or a disaccharide or a combination of both. Preferably, the osmotic agent is a dehydrated food.

The present invention also provides a direct osmotic concentration element comprising:

(a) a plurality of tubes or hollow fibers bundled together in the same orientation having void spaces between the tubes or hollow fibers, and having two outer ends, wherein each tube or hollow fiber has a hollow center;

(b) a first chamber for collecting dirty water, wherein the hollow center of each tube or hollow fiber communicates with the first chamber and voids between tubes do not communicate with the first chamber; and

(c) a second chamber for an osmotic agent wherein a second end of the plurality of tubes or hollow fibers communicates with to the second chamber, wherein the center of each tube or hollow fiber communicates with the second chamber whereby voids between tubes are sealed.

Preferably, the osmotic concentration element further comprises a third chamber for collection of potable liquid and communicating with the second chamber. Preferably, the osmotic agent has an osmotic concentration of from about 1 bar to about 200 bar. Preferably, the osmotic agent is a carbohydrate. Most preferably, the osmotic agent is a monosaccharide or a disaccharide or a combination of both. Preferably, the osmotic agent is a dehydrated food.

The present invention further provides a process for creating potable water from a dirty or contaminated source comprising:

(a) providing an osmotic concentration element comprising of a plurality of tubes or hollow fibers bundled together in the same orientation having void spaces between the tubes or hollow fibers, wherein one end of the bundle communicates with and is sealed to a first chamber wherein the center of each tube or hollow fiber communicates with the first chamber, while voids between tubes are sealed, and wherein another end of the bundle communicates with and is sealed to a second chamber wherein the center of each tube or hollow fiber communicates with the second chamber, while voids between tubes are sealed;

(b) immersing the first chamber of the osmotic concentration element in dirty water wherein the first chamber is the lower chamber;

(c) adding an osmotic agent into the first chamber; and

(d) allowing the second chamber to be filled with a dilute solution of clean water.

Preferably, the osmotic concentration element further comprises a third chamber for collection of potable liquid and communicating with the second chamber. Preferably, the tube bundle can also be configured so that the first chamber and the second chamber are formed with opposite ends of the tube bundle protruding through opposite ends of each chamber. Preferably, the tube bundle is sealed to the first chamber and the second chamber so that the center of each tube in the tube bundle communicates with the first chamber and the second chamber while voids between the tubes are sealed. Preferably, the first chamber is filled with osmotic agent so that it contacts each tube, and the element is immersed in dirty or contaminated water with the bundle of tubes in a vertical orientation. Dirty water fills the interior of each tube and water is drawn osmotically across the membrane (i.e., tube walls) into the second chamber. Preferably, the second chamber communicates with a third chamber that serves as a collection vessel for the dilute and clean water.

The present invention further provides a passive membrane device comprising:

(a) a sealed bag made from two asymmetric membranes circumferentially sealed to each other and describing an expandable interior space;

(b) a plurality of polymeric ribs to provide structural support for the passive membrane device; and

(c) an osmotic agent contained within the expandable interior space;

whereby the osmotic agent within the expandable interior space is able to osmotically drive water across the asymmetric membrane into the interior space.

Preferably, the osmotic agent has an osmotic concentration of from about 1 bar to about 200 bar. Preferably, the osmotic agent is a carbohydrate. Most preferably, the osmotic agent is a monosaccharide or a disaccharide or a combination of both. Preferably, the osmotic agent is a dehydrated food.

### BRIEF DESCRIPTION OF THE DRAWINGS

FIG. 1 shows a front view (left) and a side view (right) for a ribbed flat embodiment of the inventive hydration bag. Specifically the hydration bag is formed with the sealing of two equal-sized membrane pieced with a series of stiffener ribs spanning across an interior space to provide structural integrity and support. The membrane pieces are heat sealed to each other. An osmotic agent (i.e., sugar powder) is placed within the interior space formed by heat-sealing the two membrane pieces. The membranes used are asymmetric membranes having a backing component as described herein.

FIG. 2 shows a scalable configuration of a spiral wound membrane element connected to a large-scale nutrient drink production system for bringing potable liquid to a village/location with only dirty water available. The osmotic agent is a syrup formulation that is fed into the membrane element. This drawing shows the second embodiment of the spiral wound element. Alternatively, syrup or another osmotic agent can be added directly into the membrane element.

FIG. 3 shows three views of the spiral wound membrane element as a wrapped spiral wound element (upper left), as an unrolled diagram to show water flow paths (upper right), and as a membrane sandwich wrap used in its formation (lower). This shows the second embodiment of the spiral wound element.

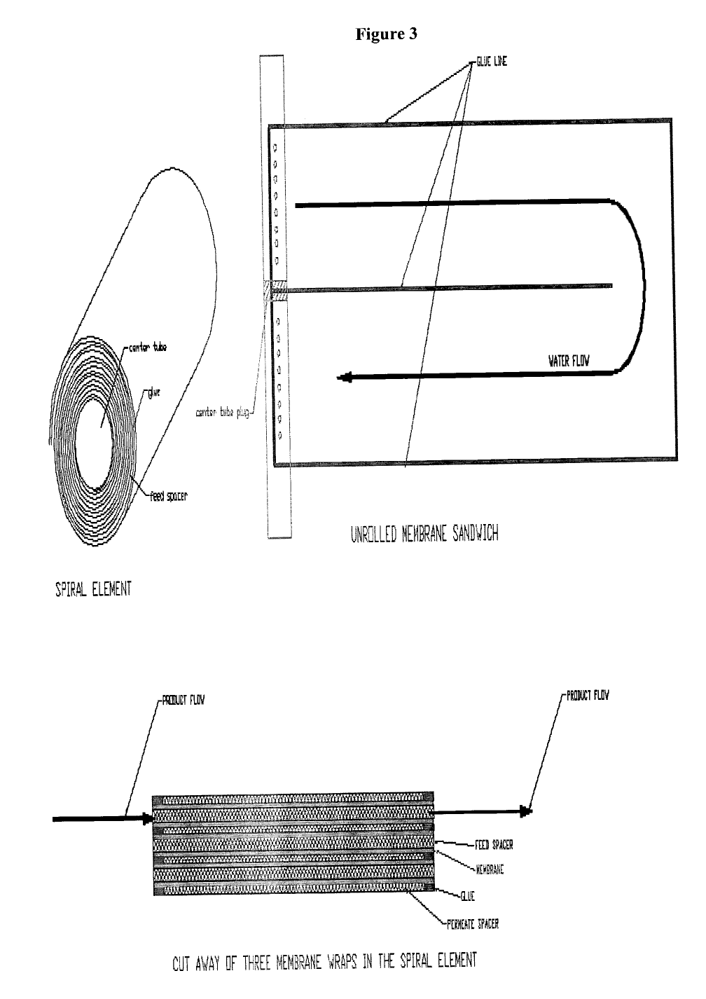

FIG. 4 shows a drawing of the spiral wound embodiment of the hydration bag with a refillable osmotic agent through a nutrient addition port communicating with a nutrient chamber and surrounded (cross section) by membrane sandwich wound around the nutrient chamber. The right hand view shows a side cross-section with the membrane element wrapped around the hollow nutrient chamber. This shows the first embodiment of the spiral wound membrane element.

FIG. 5 shows the a configuration for a wearable spiral wound membrane element hydration bag having a dirty water compartment containing the spiral wound membrane element and a nutrient drink compartment communicating with the spiral wound membrane element. This shows the first embodiment of the spiral wound element.

FIG. 6 shows an unrolled spiral wound membrane element showing flow paths through the membrane element. Specifically, the osmotic agent is a concentrated nutrient solution or syrup contained in an osmotic agent chamber (concentrated nutrient chamber). The concentrated osmotic agent is diluted with water that is ultrafiltered through a membrane to dilute the nutrients and form a drinkable solution. This shows the first embodiment of the spiral wound membrane device.

FIG. 7 shows the first embodiment of the hollow fiber osmotic device.

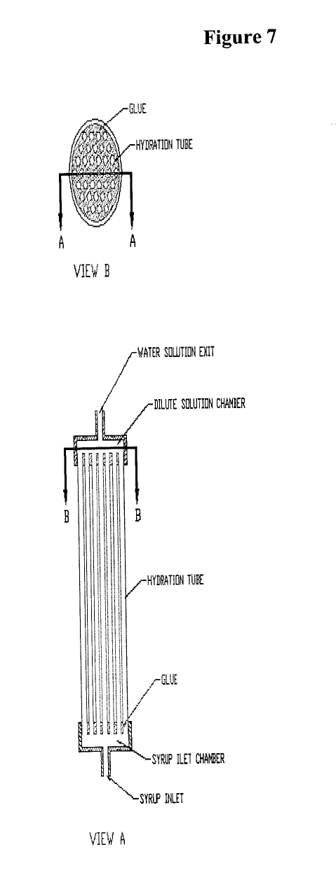

FIG. 8 shows the second embodiment of the hollow fiber osmotic device.

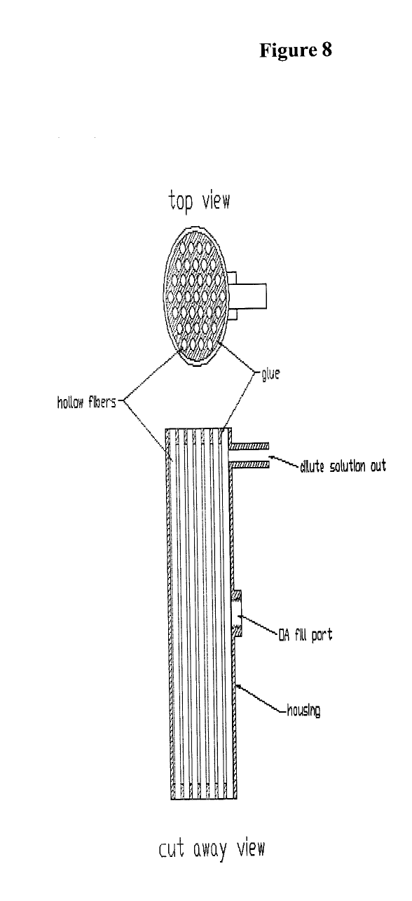

FIG. 9 shows a plate stacked osmotic membrane designed hydration bag embodiment. Specifically, the embodiment illustrated in FIG. 9 shows a hydration bag embodiment with a stacked plate and frame membrane configuration instead of a spiral wound membrane configuration. The other components of the spiral wound embodiment apply.

### DETAILED DESCRIPTION OF THE INVENTION

Flat Embodiment

The present invention provides a hydration bag and a method for manufacturing a hydration bag. In a first embodiment, the flat inventive hydration bag contains an interior space having an osmotic agent contained within. However, the nature and character of the osmotic agent allows for a wide-ranging flexibility of uses for the hydration bag. For example, when the osmotic agent is simply composed of a formulation of sugars and salts, the hydration bag will create an electrolyte solution suitable for drinking or even (when pre-sterilized) intravenous administration. The hydration bag can have dehydrated blood components for reconstitution, or even dehydrated food for creation of meals by hydration without the need to boil water in a cooking process.

In the first flat bag embodiment designed for single use systems, after sealing the bag with the osmotic agent inside, the outside of the bag can be sprayed with a glycerin solution and allowed to dry. The dried bag or a number of bags can be sealed inside a polyethylene sack. This sack can then be autoclaved to sterilize the contents and the bags will be shelf-stable for years.

Sealing three sides, adding the osmotic agent, and sealing the fourth side is a preferred method for sealing of the bags.

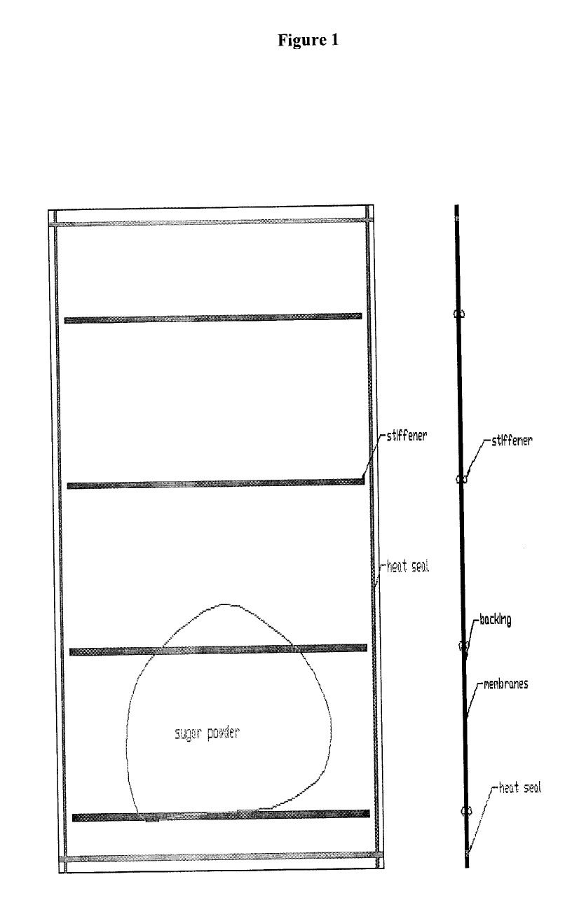

In yet another embodiment (FIG. 1) of the flat hydration bag, one can add plastic stiffener bars (from about 2 mm to about 5 mm diameter or length) on the sides of the hydration bag. This makes the solution contact more membrane during the earlier stages of the hydration, and significantly speeds up the process.

Spiral Wound, First Embodiment

The spiral wound membrane element comprises a center tube element at the center of the spiral wound element having perforations that communicate with the inside of the membrane envelope. The center tube further comprises a refillable chamber for holding the osmotic agent. Preferably, the spiral wound first embodiment is best used for military or backpacking applications. In this application a person would carry a membrane element that could be loaded with osmotic agent, preferably having some nutrient or even medicinal utility and preferably in a powder or syrup form. Within 15 minutes this spiral wound embodiment of the inventive hydration bag will begin producing a dilute solution having the nutrient or medicinal function according to the osmotic agent used. For example a nutrient solution is a balanced oral rehydration drink with a concentration of 1 to 3% solids (by weight), and it would be produced at a constant rate for 6 to 12 hours.

The size of the hydration bag is according to the desired use and desired degree of portability but is scalable to almost any size. A table of the expected performance versus size is shown below:

| Membrane | Nutrient | | | total |
|---|---|---|---|---|
| element weight | weight | size | rate | fluid/charge |
| 500 g | 250 g | 30 cm × | 0.7 liter/hr | 7-10 liters |
| | | 6 cm dia | | |
| 300 g | 150 g | 20 cm × | 0.4 liter/hr | 3-5 liters |
| | | 6 cm dia | | |

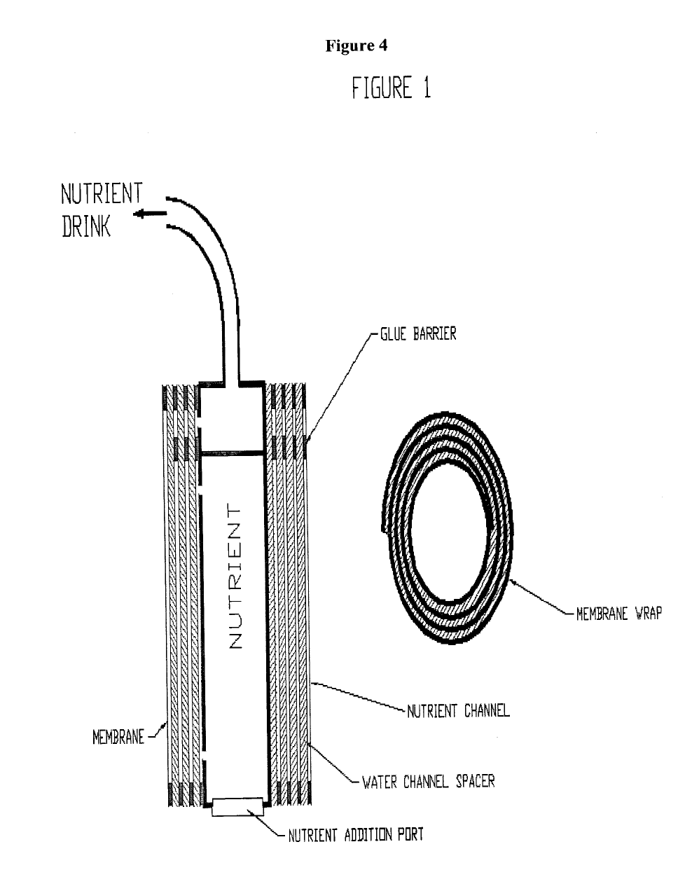

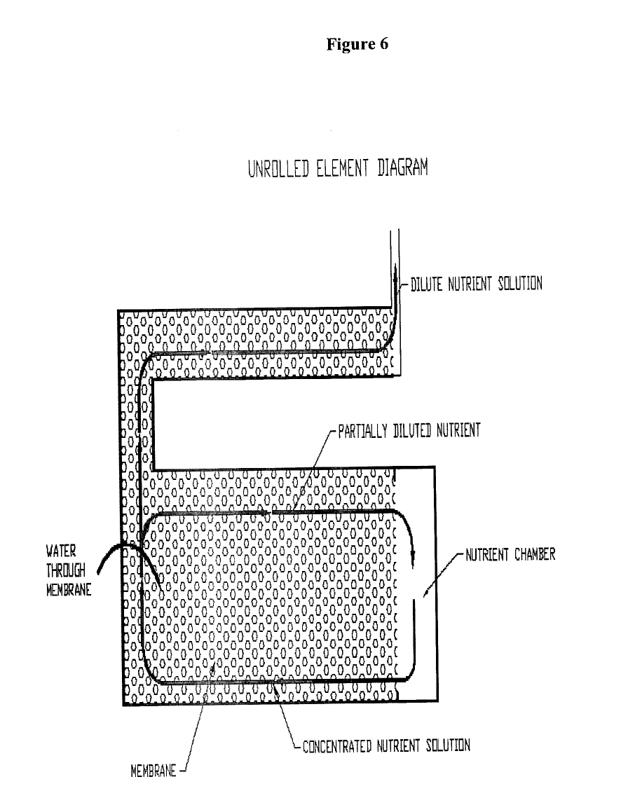

A drawing of the device is shown in FIGS. 4 and 6. FIG. 4 shows an end view of the spiral wound membrane element and a side cross-section, while FIG. 6 shows the spiral wound membrane element as it would appear if it were unwound. To operate the spiral wound membrane element, nutrient powder or syrup (osmotic agent) is introduced into the osmotic agent chamber through an osmotic agent port. The osmotic agent port is plugged, and the spiral wound membrane element is placed in any available water. The element operation is unhindered by highly turbid dirty water. The available or dirty water comprises a dirty water chamber or bag that is carried or worn is a backpacking embodiment. Ambient or available water from a questionable source is used to fill the dirty water spacer through the openings, optionally located on either end. Initially water is pulled through the membrane element because during filling of the osmotic agent or nutrient powder, a small amount of the powder migrates from the osmotic agent chamber through the transfer holes into the nutrient channel and comes into contact with the membrane. When the dirty water is introduced, this osmotic agent in the form of a dry powder or syrup hydrates by osmotically pulling water from the dirty water channel across the membrane. A diluted clean (nutrient) solution then fills the nutrient channel, and some of the solution enters the osmotic agent chamber, gradually diluting the nutrient there.

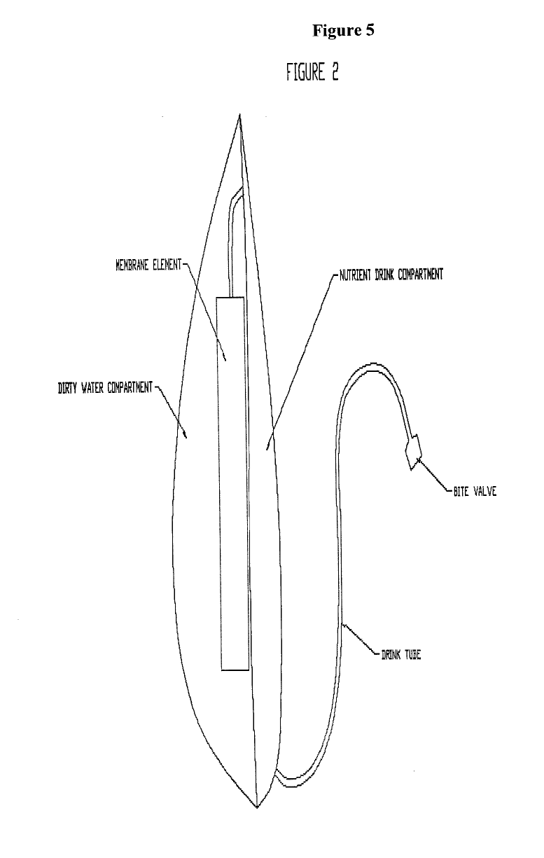

The device could be used in two ways. Firstly, the spiral wound membrane element is loaded with osmotic agent in the form of a nutrient mix (or one having medicinal value) and placed in a questionable purity water source overnight. The clean (nutrient) solution produced would be collected in a bag and drunk as needed. The second use would be to load the spiral wound membrane element osmotic agent chamber with nutrient solution syrup and put the spiral wound membrane element in a bag as shown in FIG. 5. In this “backpacking” application, dirty water is carried with the user and during the day the nutrient solution fills the nutrient drink section of the bag. The user could drink the solution as it is produced during the day through a tube from the bottom of the bag.

The spiral wound membrane element embodiment of the inventive hydration bag can be reused if it is stored in a dilute sterilizer solution. For example, for storage, the spiral wound membrane element is detached from the drink collector bag and placed in a sealed, water-filled container with an initial concentration of iodine, chlorine or sodium metabisulfite below 25 ppm. The sterilizer solution can pass through the membrane to sterilize the entire spiral wound membrane element. Upon reuse, the storage water is discarded and very little oxidizer remains in the spiral wound membrane element. As a result, little off-taste is imparted to the later-made nutrient drink. The oxidizer will eventually degrade the membrane, but it expected that at least 50 uses will be obtained. After many uses, the ability of the spiral wound membrane element to keep the sugar from crossing into the dirty water chamber will be degraded and the element will begin to produce less drink. The size of sugar molecules is far smaller than any biological agents so the element will continue to block biological contamination even as its performance degrades. This loss in drink volume produced will indicate a new membrane element is needed.

Another feature of the spiral wound membrane element embodiment of the inventive hydration bag that helps it avoid fouling is the “self-flushing” design of the dirty water channel. During operation, dissolved solids in the dirty water tend to be concentrated in the dirty water channel as water is pulled into the nutrient channel. If the solids are not flushed out they can reduce performance or precipitate in the channel. The spiral wound membrane element embodiment of the inventive hydration bag device avoids this problem because when it is completely immersed in water with its exit tube pointing up (out of the water it is immersed in), water in the dirty water channel that becomes concentrated with solids will flow out the bottom of the element. This happens due to the increase in density of the solids-enriched water.

A significant, and very desirable feature of the spiral wound membrane element embodiment of the inventive hydration bag is it produces a dilute nutrient solution at a constant rate with a simple-to-operate device. The drink is potentially sterile and good tasting, and the powder or syrup used to load the device is a nutrient that the user needs to ingest in any case. Moreover, a 100 g charge of osmotic agent/nutrient, for example, produces 3-5 liters of drink that, in most circumstances, is enough for a hiker or soldier for a day. The combined weight of the element and powder to produce drinking water for a week is 1 kg.

Two factors enabling the steady production of a dilute drink are (1) the center tube of the spiral wound membrane element has a limited number of holes. This keeps the osmotic agent/nutrient from dissolving quickly and keeps the supply of osmotic agent/nutrient to the osmotic agent/nutrient channel slow and steady. Moreover, (2), to exit, the osmotic agent/nutrient must spiral to the outermost portion of the membrane element and then spiral back in. This is accomplished by putting a plug in the center tube between the nutrient chamber and the exit, and by putting a glue line in the nutrient channel to force the solution spiral outward and back in. The reason for this feature is to only allow the most dilute solution from the element.

Spiral Wound, Second Embodiment

In the second embodiment of the spiral design, the element has a similar construction as the first embodiment. That is it has a plug in the center tube and a glue line down the center of the membrane envelope which forces fluid flow to spiral to the outside of the element and back in again. However in the second embodiment the dirty water is fed through the element and a nutrient syrup is fed to the outside of the membrane envelope. In this design the syrup is fed continuously and the element is capable of producing more concentrated drink in high volumes. This design would be useful in truck mounted or stationary aid stations for refugee populations, or for mobile kitchens for the military.

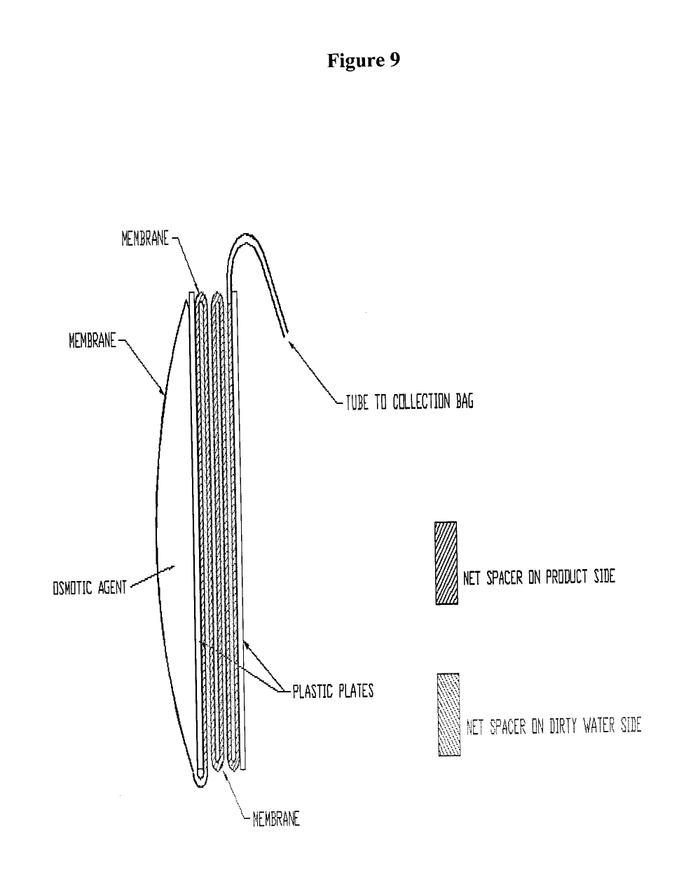

In a third embodiment illustrated in FIG. 9, the membrane of this embodiment is configured in a plate and frame format instead of a spiral wound format.

Membranes

The membranes used in the inventive hydration bags (in any configuration) are hydrophilic, cellulose-ester based membranes with salt rejections in the 80% to 95% range when tested as reverse osmosis membrane (60 psi, 500 PPM NaCl, 10% recovery, 25° C.). Preferably, the membranes are asymmetric and are formed by the immersion precipitation process. The membranes are either unbacked, or have a very open backing that does not impede water reaching the rejection layer, or are hydrophilic and easily wick water to the membrane.

The flat embodiment hydration bags are preferably formed with the rejection side (i.e., non-backed side) facing towards the inside. This is done so the sugar or other osmotic agents do not need to diffuse through the porous sublayer of the membrane to reach the rejection layer. The flux rates are higher with this configuration than with the membrane rejection layer to the outside.

The membrane used in the spiral wound element embodiment is preferably a hydrophilic, cellulose-based membrane cast by the immersion precipitation process. The nominal molecular weight cut-off of the membrane is 100 daltons.

The inventive hydration bags remain sterile on the inside after immersion because a preferred asymmetric membrane has a molecular-weight cutoff of 150 to 300 daltons. The smallest infectious microbial agents have a molecular weight over 10,000.

The hydration bags might be used as is for IV solution bags as well as drinkable solutions.

Another method of making the inventive hydration bags is to spray a solid border on the support fabric before casting the membrane on it. The membrane is cast onto a drum.

Making the Flat Embodiment Hydration Bags

Hydration bags are preferably made from a casted membrane made from a hydrophilic membrane material, for example, cellulose acetate, cellulose proprianate, cellulose butyrate, cellulose diacetate, blends of cellulosic materials, polyurethane, polyamides. Preferably the membranes are asymmetric, that is the membrane has a thin rejection layer on the order of 10 microns thick and a porous sublayer up to 300 microns thick. For mechanical strength they are in one embodiment cast upon a hydrophobic porous sheet backing, wherein the porous sheet is either woven or non-woven but having at least about 30% open area. Preferably, the woven backing sheet is a polyester screen having a total thickness of about 65 microns (polyester screen) and total asymmetric membrane is 165 microns in thickness. Preferably, the asymmetric membrane was caste by an immersion precipitation process by casting the cellulose material onto the polyester screen. In a preferred embodiment, the polyester screen was 65 microns thick, 55% open area.

In a second support sheet embodiment, the membrane is cast on a dense hydrophilic material which wicks water easily through it. Backings that have this property include, for example, cotton paper and surface modified polypropylene.

For bag production, casted asymmetric membrane material had the water in it replaced with glycerin. However, one can use other materials, such as soaps or ethylene glycols or other glycols. However, glycerin is appropriate because it is food grade. The asymmetric membrane is immersed in a glycerin bath and the glycerin, by diffusion, replaces the water.

Cellulosic membranes are difficult to seal due to the weakness of the porous sublayer and the nonweldability of cellulose. One technique used to weld membrane to windows in polymeric sheets employed a solvent welding step. Borders are laid out (painted on or sprayed on the membrane) with acrylic solvent by solvent welding to the backed side of the membrane. On a piece of medical-grade PVC, a window is cut out (about 18×25 cm) and piece of membrane with acrylic borders is radio frequency welded such that the membrane covers the window in the PVC sheet. Preferably, the backing side of the membrane is welded to the frame of the window on the PVC sheet.

A hydration bag can have either a one-sided membrane or a two-sided membrane. A one-sided hydration bag is designed to float on the surface of water, membrane-side down. A two-sided hydration bag was designed to have a vertical alignment in a body of water, such that the outer membrane surface areas is preferably immersed in the water.

For the one-sided hydration bag, a second, solid sheet of PVC is welded (radio frequency welding process is preferred) to the first sheet of PVC (having a window with a membrane attached thereto. Preferably the welding of the two PVC sheets is done with a larger, circumferential perimeter weld layer. The outer weld is made such that the membrane/PVC weld is not subject to as much stress. In a two-sided embodiment, the PVC-windowed sheets are welded to each other, again with the PVC/PVC weld in an outer circumferential location.

Preferably, an osmotic agent is placed within the interior space formed by welding the PVC sheets. In the one-sided 18×25 area membrane hydration bag, approximately 100 g of dextrose powder was added as an osmotic agent.

Another process for producing the inventive hydration bags is to cast the membrane onto a weldable hydrophilic backing. Weldable hydrophilic backings include, for example, dense polypropylene nonwoven fabric that has been surface modified with acrylic acid to make it hydrophilic. The membrane for use in the inventive hydration bag is cast so that it does not penetrate the weldable hydrophilic backing. The weldable hydrophilic backing is then be welded to itself or to a PVC window to form the inventive hydration bag according to the embodiments described herein. If it is welded to itself the bag produced will have its membrane face outward, that is the weldable backing material will be inward within the hydration bag. If the membrane having the weldable hydrophilic backing is welded to a window cut within a polymeric sheet (e.g., PVC), the membrane faces inward again and the weldable hydrophilic backing side of the membrane will face outward on this embodiment of the inventive hydration bag. In either case no solvent welding of the membrane is required.

Making the Spiral Wound Membrane Element Second Embodiment

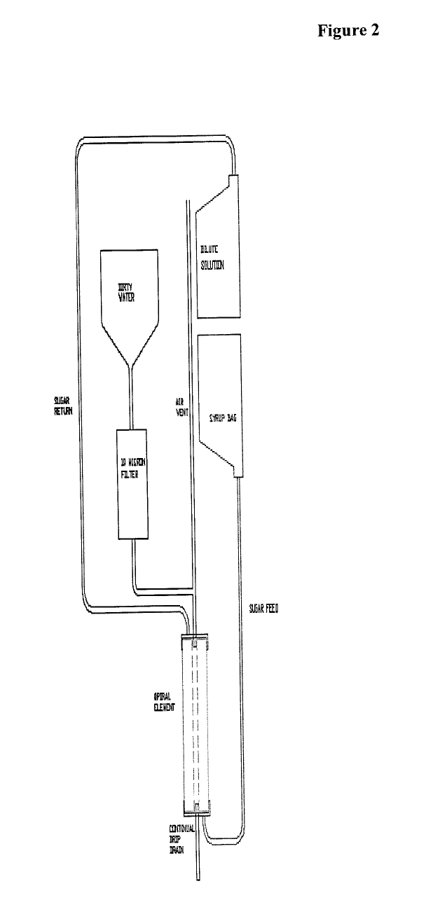

The second embodiment inventive hydration bag can be a smaller bag that can be carried by a backpacker or a soldier (FIG. 5) or a larger hydration design spiral-wound element (FIG. 2). The spiral wound membrane element is similar to a conventional spiral wound RO (reverse osmosis) element except there is a glue line down the center of the membrane envelope on the permeate side, and there is plug in the center of the permeate tube.

The second embodiment inventive hydration bag operates by introducing any water available to what would be the permeate side of the RO element. A syrup (osmotic agent) is then introduced to the feed side and osmosis pulls water from the water side of the membrane into the sugar. A small amount of water is continually drained from the element to prevent the build-up of contaminants on the water side of the membrane.

Fluid moves from the syrup bag to the dilute bag, even though the dilute bag is higher, because of density differences between the dilute and concentrated fluids. As the syrup becomes diluted in the element its density decreases and the column of dilute fluid above the element is higher than the column of syrup. This height difference can be used to set the concentration of the fluid coming out. This setting will be determined during the design phase and will not need to be adjusted in the field.

Another method of adjusting the rate of osmotic agent being fed to the element is to use a drip system similar to that used in IV applications to supply osmotic agent to the bottom of the element.

Initial testing of an element with about 0.3 m² membrane produced 20 ml/min of a 10% glucose with a 60% glucose feed at 30° C. A 35 cm diameter by 60 cm long spiral wound membrane element produces about 1 liter/min of a 5 to 10% solution.

The application for this system is in relief work where getting water to the site is difficult.

Osmotic Agent

The powder in the bag should be primarily a monosaccharide (e.g., glucose) but can contain flavors, salts, vitamins or medicines as desired. The hydration time for a single bag in a horizontal orientation was 1.2 L in 7 hrs and 40 min at 16.5° C. A preferred osmotic agent was Sodium chloride=6.21 wt %, Potassium chloride=7.92 wt %, Trisodium citrate=10.41 wt %, Glucose=58.24 wt %, and Fructose=17.22 wt %. Other osmotic agents (or hydration formulations) include, for example, medicines within a dextrose formulation, dehydrated foods, and any other solute that can be hydrated with water.

The nutrients form of osmotic agents can be powders or syrups made from the following: fructose, sucrose, glucose, sodium citrate, potassium citrate, citric acid, potassium ascorbate, sodium ascorbate, ascorbic acid, water soluble vitamins, sodium chloride, and potassium chloride. For example, a mixture of 60% fructose, 10% potassium citrate, 10% sodium citrate and 20% water was tested in the 30 cm element and had performance similar to 80% fructose-20% water nutrient syrup.

The preferred osmotic agents that are nutrients include, for example, fructose, glucose, sucrose, sodium citrate, potassium citrate, sodium ascorbate, potassium ascorbate, and other water-soluble vitamins. Flavorings and aspartame can be added to improve the taste.

### EXAMPLE 1

This example illustrates the manufacturing of a batch of inventive hydration bags that were used for testing in the subsequent examples. The subsequent examples tested the hydration bag for permeation by various agents, including black pigment-based ink, bacterium Escherichia coli, bacteriophage MS2, bacteriophage M13 mp18 (a derivative of the f1 coliphage); purified DNA from M13 phage.

Hydration bags were made from a casted membrane made from cellulose triacetate ester, asymmetric with a polyester screen having a total thickness of 65 microns (polyester screen) and total membrane is 165 microns. The asymmetric membrane was caste by an immersion precipitation process by casting the cellulose material onto the polyester screen. The polyester screen was 65 microns thick, 55% open area.

Casted asymmetric membrane material had the water in it replaced with glycerin. The asymmetric membrane was immersed in a glycerin bath and the glycerin, by diffusion, replaced the water.

Borders were laid out (painted on or sprayed on the membrane) with acrylic solvent by solvent welding to the backed side of the membrane. On a piece of medical-grade PVC, a window was cut out (about 18×25 cm) and radio frequency weld the PVC sheet to the membrane such that the membrane the window in the PVC sheet. Preferably, the backing side of the membrane was welded to the frame of the window on the PVC sheet. This process was repeated many times for each hydration bag. A hydration bag can have either a one-sided membrane or a two-sided membrane. One-sided hydration bags were used for the tests described below.

For the one-sided bag, a second, solid sheet of PVC was welded (radio frequency welding) to the first sheet of PVC (having a window with a membrane attached thereto). The welding of the two PVC sheets was done with a larger, circumferential perimeter weld layer. The outer weld was made such that the membrane/PVC weld was not subject to as much stress.

An osmotic agent was placed within the interior space formed by welding the PVC sheets. In the one-sided 18×25 area membrane hydration bag, approximately 100 g of dextrose powder was added as an osmotic agent.

### EXAMPLE 2

This example provides an experiment wherein the inventive hydration bag was tested for permeation through the membrane and structures the inventive hydration bag. The bag was immersed in a suspension of diluted black inkjet ink made from pure carbon-based pigment particles (Cone Editions, Inc., Bradford, Vt.). The diameter of the pigment particles was in the range of 0.4-1.0 μm. The bag was kept immersed in 2 liters of ink for 1 hour and then for 24 hours. Approximately 250 ml of water accumulated inside the bag. Measuring light absorption of the accumulated water-sugar solution in a Beckman Spectrophotometer using ink dilutions as controls carried out evaluation of ink permeation. The results are shown in Table 1.

TABLE 1
Pigment ink permeation tests

| Pigment ink | A₆₀₀ of water sample | A₆₀₀ of water sample in bag |
|---|---|---|
| dilution/A₆₀₀ | in bag after 1 hour | after 24 hours |
| 10⁻² - >1.86 | 0 | 0 |
| 10⁻⁴ - >1.86 | 0 | 0 |
| 10⁻⁵ - 1.32 | 0 | 0 |
| 10⁻⁶ - 0.55 | 0 | 0 |
| 10⁻⁷ - 0.08 | 0 | 0 |
| 10⁻⁸ - ˜0.01 | 0 | 0 |
| 10⁻⁹ - 0 | 0 | 0 |

These data clearly indicate that there was no permeation of the pigment particles through the hydration bag membrane.

### EXAMPLE 3

This example provides an experiment wherein the inventive hydration bag was tested for E. coli permeation through the membrane and structures the inventive hydration bag. E. coli (non-pathogenic laboratory strain HB 101) was grown in liquid LB medium overnight (LB medium (per liter; in DI water): 10 g trypton (Difco), 5 g yeast extract (Difco), 5 g NaCl (Sigma), 1 ml 1N NaOH. Sterilized in autoclave). Two parallel cell suspensions were diluted to a density of 10⁶ and 10⁸ bacteria per ml culture in a 4-liter plastic container. Two inventive hydration bags were immersed into the bacterial suspension; one for 1 hour and the other for 24 hours at room temperature (˜21° C.). Passage of bacteria through the membrane was tested by colony counts on LB-agar plates.

The container and liquids with bacteria were disinfected with Clorox® Bleach after each experiment.

A control experiment was carried out to test if the osmotic formulation water-sugar solution affected in any way viability of the bacteria. For this purpose, a bacterial suspension (10³ cells per ml) was incubated for 1 hour and 24 hours in the (tainted) water-sugar solution produced in the bags, followed by assessing plating efficiency.

TABLE 2
E. coli permeation test results

| Colony counts | Bacteria in water sample | Bacteria in water sample |
|---|---|---|
| of bacteria | in bag after 1 hour | in bag after 24 hours |
| 10⁶/ml | 0 | 0 |
| 10⁸/ml | 0 | 0 |
| 10³/ml (tainted | 974 | 1148 |
| water-sugar | | |
| solution; | | |
| viability control) | | |

These data demonstrated no passage (permeation) of bacteria through the membrane of the hydration bag. Statistical analysis of the data was not needed.

### EXAMPLE 4

This example provides an experiment wherein the inventive hydration bag was tested for M3 phage permeation through the membrane and structures the inventive hydration bag. M13 (strain mp18), a known derivative of the non-pathogenic f1 filamentous coliphage, was grown in the non-pathogenic laboratory strain E. coli JM 101. This phage particle carries a single-stranded DNA genome. The phage was produced in the bacterial host by infecting a liquid culture of E. coli in LB medium overnight. Bacteria were precipitated by centrifugation and the phage particles were purified from the growth medium by precipitation with polyethylene glycol (PEG) solution (5×; in 700 ml H₂O: 414 g PEG 6000, 12 g dextran sulfate, 99 g NaCl.) and re-suspension in the 4-liter water sample, in which the hydration bags were immersed. Phage concentrations were assessed by counting the phage plaques on continuous lawns of E. coli cells in petri dishes. Two phage dilutions were used in a 4-liter plastic container: 10⁷ and 10⁹ phage particles per ml. Two hydration bags were immersed into the phage suspension; one for 1 hour and the other for 24 hours at room temperature (˜21° C.). Passage of phage through the membrane was tested by infecting a 10-ml culture of E. coli, followed plaque counts on LB-agar plates in a continuous lawn of E. coli.

The container and liquids with bacteria and phages were disinfected with Clorox® Bleach after each experiment.

TABLE 3
M13 phage permeation test results

| | Phage count in water | Phage count in water |
|---|---|---|
| | sample from bag after | sample from bag after |
| Phage counts | 1 hour | 24 hours |
| 10⁷/ml | 0 | 0 |
| 10⁹/ml | 0 | 0 |

These data demonstrated no passage (permeation) of the M13 phage through the membrane of the hydration bag. Statistical analysis of the data was not needed.

### EXAMPLE 5

This example provides an experiment wherein the inventive hydration bag was tested for MS2 phage permeation through the membrane and structures the inventive hydration bag. These tests were carried out with the MS2 bacteriophage in the same way (see above) as the experiments with M13 phage (example 3), except that the phage particle concentrations in the 4-liter water sample were 10⁶/ml and 10⁸/ml. The results were similar in that no phage particles passage through the membrane was observed.

### EXAMPLE 6

This example provides an experiment wherein the inventive hydration bag was tested for M13 phage permeation through the membrane and structures the inventive hydration bag. The DNA of the M13 phage was used in a series of experiments designed to test if an infectious viral DNA were able to penetrate through the hydration bag's membrane. M13 DNA is a circular single-stranded molecule of ˜7,250 nucleotides, which corresponds to a molecular weight of approximately 2.4×10⁶ daltons. In comparison, the double-stranded circular DNA of the poliovirus is of 4,500-nucleotide pairs, corresponding to ˜3×10⁶ daltons.

Phage DNA was purified from the phage particles obtained from the E. coli liquid culture supernatant by PEG precipitation (see method in example 4). The phage pellet precipitated by PEG was re-suspended in 2 ml of TE buffer (10 mM Tris.HCl, pH 7.5; 1 mM EDTA) extracted with 1 ml of buffered phenol, and the DNA was precipitated with 3M sodium acetate and dried after washing with 70% cold ethanol.

2 mg of phage DNA was dissolved in 4 liters of test water, and the hydration bags were immersed for 1 hour and 24 hours, consistently to the experimental conditions described in examples 2-5 above.

The phage DNA was collected from 100 ml of water samples from inside and outside the bags by running through a DEAE-cellulose ion exchange chromatography column (1×3 cm). Bound DNA was eluted in 1 ml 0.45 M LiCl, and used directly to transfect E. coli. Phage plaques were formed overnight and counted (Table 4).

TABLE 4
M13 phage DNA permeation test results

| Phage plaque count in | Phage plaque count | Phage plaque count |
|---|---|---|
| water sample outside of | in water sample from | in water sample from |
| bag¹ | bag after 1 hour | bag after 24 hours |
| After 1 hour: 9,350/ml | 0 (/ml) | 0 (/ml) |
| After 24 hours: 9,140/ml | | |

¹Appropriate dilutions were used for phage plaque enumeration.

These data show that no bacteriophage DNA passed through the bag membrane under the experimental conditions applied.

### EXAMPLE 7

This example illustrates the making of a second embodiment inventive hydration bag having a spiral wound membrane element. The membrane element was a 30 cm by 6 cm diameter Membrane having a total area of about 0.65 m². The nutrient or osmotic agent was 300 g of an 80% fructose solution. When immersed in 20° C. water the element began producing 1.4 bx solution within 10 minutes. The production was steady at 900 to 1000 ml/hour and 1.2 to 1.4 bx for the first 6 hours. After 24 hours the element had produced 14 liters of solution averaging 1.1 bx.

### EXAMPLE 8

This example illustrates the making of a second embodiment inventive hydration bag having a spiral wound membrane element. The membrane element was 16 cm by 6 cm diameter with a membrane having a surface area of about 0.3 m². The nutrient/osmotic agent was 140 g of an 80% fructose solution.

When immersed in 20° C. water the membrane element began producing 1.4 bx solution within 10 minutes. The production was steady at 400 to 450 ml/hour and 1.1 to 1.4 bx for the first 6 hours. After 24 hours the element had produced 6 liters of solution.

### EXAMPLE 9

This example illustrates the making of a second embodiment hydration bag having a spiral wound membrane element. An element with the following characteristics was constructed:

effective membrane area—0.5 m²

diameter—6 cm

Osmotic agent chamber diameter—3 cm

length—30 cm

nutrient chamber length—25 cm

200 g Gatorade® powder as the nutrient charge.

The element was immersed in 25° C. water and after 15 minutes began producing a 2% solution of Gatorade® at a rate of 20 ml/min. The production rate remained steady for 6 hours in which time it had produced 6.7 liters with an average strength of a 2.2%. After 20 hours it had produced 12 liters with an average strength of 1.7%.

I claim:

1. A passive membrane device to provide potable water, medicine, sterile solutions and the like, comprising:
(a) a sealed bag made from two flexible polymeric sheets circumferentially sealed to each other and describing an expandable interior space, wherein at least one of the sheets comprises a window cut out;
(b) an asymmetric membrane mounted within the window cut out of the polymeric sheet, wherein the asymmetric membrane comprises a polymeric material caste upon a porous woven or non-woven sheet or screen having at least 30% open area; and
(c) an osmotic agent contained within the expandable interior space;
whereby the osmotic agent within the expandable interior space is able to osmotically drive water across the asymmetric membrane into the interior space.

2. The passive membrane device of claim 1 wherein, the polymeric sheets are made from a non-porous and flexible plastic in a sheet form.

3. The passive membrane device of claim 2 wherein, the polymeric sheets are made from a polymeric material selected from the group consisting of PVC (polyvinyl chloride), polyethylene, polycarbonate, vinyl chloride, and combinations thereof.

4. The passive membrane device of claim 3 wherein, the polymeric sheet is made from PVC.

5. The passive membrane device of claim 1 wherein, the window cut out is in the shape of a rectangle.

6. The passive membrane device of claim 1 wherein, the asymmetric membranes are backed with a woven sheet.

7. The passive membrane device of claim 6 wherein, the woven sheet is a polyester screen.

8. The passive membrane device of claim 1 wherein, the porous sheet contains from about 30% to about 80% open area.

9. The passive membrane device of claim 6 wherein, the woven sheet comprises a dense polypropylene nonwoven fabric that has been surface modified with acrylic acid to make it hydrophilic.

10. The passive membrane device of claim 1 wherein, the asymmetric membrane is from about 100 to about 300 microns thick (including the woven sheet).

11. The passive membrane device of claim 1 wherein, the asymmetric membrane is made from a hydrophilic membrane forming material.

12. The passive membrane device of claim 11 wherein, the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof.

13. The passive membrane device of claim 12 wherein, the membrane material is cellulose triacetate.

14. The passive membrane device of claim 1 wherein, the asymmetric membrane has its water replaced by a polyhydroxy compound.

15. The passive membrane device of claim 14 wherein, the polyhydroxy compound is selected from the group consisting of glycerin, ethyldialcohol, ethylene glycol, a C₂₋₁₀ saturated or unsaturated fatty acid, and combinations thereof.

16. The passive membrane device of claim 15 wherein, the polyhydroxy compound is glycerin.

17. The passive membrane device of claim 1 wherein, the osmotic agent has an osmotic concentration of from about 1 bar to about 200 bar.

18. The passive membrane device of claim 1 wherein, the osmotic agent is a monosaccharide or a disaccharide or a combination of both.

19. The passive membrane device of claim 1 wherein, the osmotic agent is a dehydrated food.

20. A process for manufacturing a hydration bag having two sided walls, wherein the hydration bag comprises a sealed bag having a membrane wall and an osmotic agent contained within, comprising:
(a) providing two flexible polymeric sheets, each shaped for a side wall of the hydration bag, and wherein at least one of the flexible polymeric sheets comprises a window cut out;
(b) providing an asymmetric membrane comprising a polymeric material cast upon a porous woven or non-woven sheet or screen having at least 30% open area;
(c) adhering the asymmetric membrane to cover the window on one or two flexible polymeric sheets;
(d) placing a dried osmotic agent on the membrane adhered within the window of a flexible polymeric sheet; and
(e) adhering two flexible polymeric sheets to each other by forming a weld circumferentially around the asymmetric membrane, whereby such that a bag is formed having the osmotic agent contained within an interior space.

21. The process for manufacturing a hydration bag having two side walls of claim 20, wherein the process further comprises (a′) replacing water within the asymmetric membrane with a polyhydroxy compound.

22. The process for manufacturing a hydration bag having two side walls of claim 21, wherein the polyhydroxy compound is selected from the group consisting of glycerin, ethyldialcohol, ethylene glycol, a C₂₋₁₀ saturated or unsaturated fatty acid, and combinations thereof.

23. The process for manufacturing a hydration bag having two side walls of claim 22, wherein the polyhydroxy compound is glycerin.

24. The process for manufacturing a hydration bag having two side walls of claim 20, wherein the process for (c) adhering the asymmetric membrane to cover the window on one or two flexible polymeric sheets, comprises a process selected from the group consisting of solvent welding, gluing, epoxy-bonding, heat-bonding, radio frequency welding, and combinations thereof.

25. The process for manufacturing a hydration bag having two side walls of claim 24, wherein the process for adhering the asymmetric membrane is selected from the group consisting of solvent welding, radio frequency welding the backing side of the asymmetric membrane or side having the porous sheet or screen to the flexible polymeric sheet, and combinations thereof.

26. The process for manufacturing a hydration bag having two side walls of claim 20, wherein the backing side of the asymmetric membrane or side having the porous sheet or screen is adhered to the flexible polymeric sheet.

27. The process for manufacturing a hydration bag having two side walls of claim 20, wherein the polymeric sheets are made from a non-porous and flexible plastic in a sheet form.

28. The process for manufacturing a hydration bag having two side walls of claim 27, wherein the polymeric sheets are made from a polymeric material selected from the group consisting of PVC (polyvinyl chloride), polyethylene, polycarbonate, vinyl chloride, and combinations thereof.

29. The process for manufacturing a hydration bag having two side walls of claim 20, wherein the asymmetric membranes are backed with a woven sheet.

30. The process for manufacturing a hydration bag having two side walls of claim 29, wherein the woven sheet is a polyester screen.

31. The process for manufacturing a hydration bag having two side walls of claim 20, wherein the porous sheet contains from about 30% to about 80% open area.

32. The process for manufacturing a hydration bag having two side walls of claim 20, wherein the asymmetric membrane is from about 100 to about 300 microns thick (including the woven sheet).

33. The process for manufacturing a hydration bag having two side walls of claim 20, wherein the asymmetric membrane is made from a hydrophilic membrane forming material.

34. The process for manufacturing a hydration bag having two side walls of claim 36, wherein the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof.

35. The process for manufacturing a hydration bag having two side walls of claim 20, wherein the osmotic agent has an osmotic concentration of from about 2 bar to about 200 bar.

36. The process for manufacturing a hydration bag having two side walls of claim 20, wherein the osmotic agent is a monosaccharide or a disaccharide or a combination of both.

37. The process for manufacturing a hydration bag having two side walls of claim 20, wherein the osmotic agent is a dehydrated food.

38. The process for manufacturing a hydration bag having two side walls of claim 20, wherein the process (e) adhering two flexible polymeric sheets to each other by forming a weld circumferentially around the asymmetric membrane, comprises an adhering process selected from the group consisting of radio frequency welding, gluing, epoxy welding, heat fusing, solvent welding, clamping, sonic bonding, and combinations thereof.

39. A passive membrane device comprising:
(a) a sealed bag made from two asymmetric membranes circumferentially sealed to each other and describing an expandable interior space;
(b) a plurality of polymeric ribs to provide structural support for the passive membrane device; and
(c) an osmotic agent contained within the expandable interior space;
whereby the osmotic agent within the expandable interior space is able to osmotically drive water across the asymmetric membrane into the interior space.

40. A reusable, spiral wound passive membrane device comprising:
(a) a spiral wound membrane element comprising a membrane sandwich wound around a perforated osmotic agent tube, wherein the osmotic agent perforated tube having two sealable ends and lateral walls, wherein the osmotic agent perforated tube comprises a plurality of openings on the lateral walls communicating with a membrane sandwich, wherein the membrane sandwich comprises a membrane, a permeate spacer, and partial length glue to form a barrier;
(b) a dirty water chamber comprising a fixed or portable container of dirty water communicating with outer portion of the spiral wound membrane envelope of the membrane element; and
(c) a potable water compartment communicating with interior of the membrane envelope of the membrane element.

41. The reusable, spiral wound passive membrane device of claim 40, wherein the membrane in the membrane element is an asymmetric membrane having a backing with a woven or non-woven sheet.

42. The reusable, spiral wound passive membrane device of claim 41, wherein the woven sheet is a polyester screen.

43. The reusable, spiral wound passive membrane device of claim 41, wherein the porous sheet contains from about 30% to about 80% open area.

44. The reusable, spiral wound passive membrane device of claim 40, wherein the asymmetric membrane is from about 100 to about 300 microns thick (including the woven sheet).

45. The reusable, spiral wound passive membrane device of claim 40, wherein the membrane is made from a hydrophilic membrane forming material.

46. The reusable, spiral wound passive membrane device of claim 45, wherein the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof.

47. The reusable, spiral wound passive membrane device of claim 46, wherein the membrane has its water replaced by a polyhydroxy compound.

48. The reusable, spiral wound passive membrane device of claim 47, wherein the polyhydroxy compound is selected from the group consisting of glycerin, ethyldialcohol, ethylene glycol, a C₂₋₁₀ saturated or unsaturated fatty acid, and combinations thereof.

49. The reusable, spiral wound passive membrane device of claim 40, wherein the osmotic agent is a carbohydrate or a dehydrated food.

50. A reusable, spiral wound passive membrane device comprising:
(a) a spiral wound element having an inner portion and an outer portion, comprising a membrane sandwich that winds around a perforated feed tube to form the inner portion, wherein the perforated feed tube comprises two sealable ends and lateral walls, wherein the perforated feed tube further comprises a plurality of openings on the lateral walls communicating with a membrane sandwich, wherein the membrane sandwich comprises a sandwich having a membrane element, a permeate spacer element, and a partial length barrier forming an elongated chamber within the membrane sandwich, wherein the outer portion of the spiral wound element comprises openings communicating with the permeate spacer element;
(b) an osmotic agent chamber comprising a fixed or portable container having an inlet port communicating with a first sealable end of the perforated feed tube;
(c) a potable water collection chamber communicating with a second sealable end of the perforated feed tube and
(d) a water feed supply so that water is continuously fed to the elongated chamber within the membrane sandwich.

51. The reusable, spiral wound passive membrane device of claim 50 wherein the partial length barrier element is selected from the group consisting of glue, tape, a moldable polymeric material, and combinations thereof.

52. The reusable, spiral wound passive membrane device of claim 50 wherein the osmotic agent chamber further comprises an osmotic agent feed chamber communicating with the inlet port of the osmotic agent chamber.

53. The reusable, spiral wound passive membrane device of claim 50 wherein the spiral wound membrane element is oriented such that its axis is oriented in a vertical direction.

54. The reusable, spiral wound passive membrane device of claim 50 wherein the membrane in the membrane element is an asymmetric membrane.

55. The reusable, spiral wound passive membrane device of claim 54 wherein the asymmetric membrane is backed with a woven sheet.

56. The reusable, spiral wound passive membrane device of claim 55 wherein the woven sheet is a polyester screen.

57. The reusable, spiral wound passive membrane device of claim 50 wherein the porous sheet contains from about 30% to about 80% open area.

58. The reusable, spiral wound passive membrane device of claim 50 wherein the asymmetric membrane is from about 100 to about 300 microns thick (including the woven sheet).

59. The reusable, spiral wound passive membrane device of claim 50 wherein the membrane is made from a hydrophilic membrane forming material.

60. The reusable, spiral wound passive membrane device of claim 59 wherein the hydrophilic material is selected from the group consisting of cellulose-based materials, cellulose triacetate ester, cellulose triacetate, cellulose proprianate, cellulose butyrate, cellulose diacetate, blends of cellulose materials, polyurethane, polyamides, and combinations thereof.

61. The reusable, spiral wound passive membrane device of claim 60 wherein the membrane material is cellulose triacetate.

62. The reusable, spiral wound passive membrane device of claim 50 wherein the asymmetric membrane has its water replaced by a polyhydroxy compound.

63. The reusable, spiral wound passive membrane device of claim 62 wherein the polyhydroxy compound is selected from the group consisting of glycerin, ethyldialcohol, ethylene glycol, a C₂₋₁₀ saturated or unsaturated fatty acid, and combinations thereof.

64. The reusable, spiral wound passive membrane device of claim 50 wherein the osmotic agent has an osmotic concentration of from about 1 bar to about 200 bar.

65. The reusable, spiral wound passive membrane device of claim 50 wherein the osmotic agent is a carbohydrate or a dehydrated food.

66. The reusable, spiral wound passive membrane device of claim 65 wherein the osmotic agent is a monosaccharide or a disaccharide or a combination of both.

67. A direct osmotic concentration element comprising:
(a) a plurality of tubes or hollow fibers bundled together in the same orientation having void spaces between the tubes or hollow fibers, and having two outer ends, wherein each tube or hollow fiber has a hollow center;
(b) a first chamber for collecting dirty water, wherein the hollow center of each tube or hollow fiber communicates with the first chamber and voids between tubes do not communicate with the first chamber; and
(c) a second chamber for an osmotic agent wherein a second end of the plurality of tubes or hollow fibers communicates with to the second chamber, wherein the center of each tube or hollow fiber communicates with the second chamber whereby voids between tubes are scaled.

68. The direct osmotic concentration element of claim 67 wherein the osmotic concentration element further comprises a third chamber for collection of potable liquid and communicating with the second chamber.

69. The direct osmotic concentration element of claim 67 wherein the osmotic agent has an osmotic concentration of from about 1 bar to about 200 bar.

70. The direct osmotic concentration element of claim 67 wherein the osmotic agent is a carbohydrate.

71. The direct osmotic concentration element of claim 70 wherein the osmotic agent is a monosaccharide or a disaccharide or a combination of both.

72. A process for creating potable water from a dirty or contaminated source comprising:
(a) providing an osmotic concentration element comprising of a plurality of tubes or hollow fibers bundled together in the same orientation having void spaces between the tubes or hollow fibers, wherein one end of the bundle communicates with and is sealed to a first chamber wherein the center of each tube or hollow fiber communicates with the first chamber, while voids between tubes are sealed, and wherein another end of the bundle communicates with and is sealed to a second chamber wherein the center of each tube or hollow fiber communicates with the second chamber, while voids between tubes are sealed;
(b) immersing the first chamber of the osmotic concentration element in dirty water wherein the first chamber is the lower chamber;
(c) adding an osmotic agent into the first chamber; and
(d) allowing the second chamber to be filled with a dilute solution of clean water.

73. The process of claim 72 wherein the osmotic concentration element further comprises a third chamber for collection of potable liquid and communicating with the second chamber.

74. The process of claim 72 wherein the tube bundle can also be configured so that the first chamber and the second chamber are formed with opposite ends of the tube bundle protruding through opposite ends of each chamber.

75. The process of claim 72 wherein the first chamber is filled with osmotic agent so that it contacts each tube, and the element is immersed in dirty or contaminated water with the bundle of tubes in a vertical orientation, whereby dirty water fills the interior of each tube and water is drawn osmotically across the tube into the second chamber.

76. A passive membrane device comprising:
(a) a sealed bag made from two asymmetric membranes circumferentially sealed to each other and describing an expandable interior space;
(b) a plurality of polymeric ribs to provide structural support for the passive membrane device; and
(c) an osmotic agent contained within the expandable interior space;
whereby the osmotic agent within the expandable interior space is able to osmotically drive water across the asymmetric membrane into the interior space.

77. The passive membrane device of claim 76 wherein the osmotic agent has an osmotic concentration of from about 1 bar to about 200 bar.

78. The passive membrane device of claim 76 wherein the osmotic agent is a carbohydrate.

79. The passive membrane device of claim 78 wherein the osmotic agent is a monosaccharide or a disaccharide or a combination of both.

80. The passive membrane device of claim 76 wherein the osmotic agent is a dehydrated food.
